(19) United States
(12) Patent Application Publication
(10) Pub. No.: US 2013/0169230 A1
(43) Pub. Date: Jul. 4, 2013

(54) CONTACT TYPE CHARGING DEVICE USED FOR AN ELECTRONIC CIGARETTE

(71) Applicant: Shenzhen First Union Technology Co., Ltd., Shenzhen (CN)

(72) Inventors: Yong-Hai LI, Shenzhen (CN); Zhong-Li XU, Shenzhen (CN)

(73) Assignee: SHENZHEN FIRST UNION TECHNOLOGY CO., LTD., Shenzhen (CN)

(21) Appl. No.: 13/727,823

(22) Filed: Dec. 27, 2012

(30) Foreign Application Priority Data
Dec. 29, 2011 (CN) 201120561232.6

(51) Int. Cl. H02J 7/00

(52) U.S. Cl. CPC H02J 7/0044
USPC 320/114

(57) ABSTRACT

The invention relates to a contact type charging device used for the electronic cigarette, comprising a base and a contact device located on the base, wherein the contact device comprises an electrode sheet provided with a through hole at the center thereof and an electrode thimble, and the contact device further comprises a magnetic member. As the magnetic member is provided on the contact device, the charger is used more conveniently; rotatable connection does not need to be provided between the electronic cigarette and the contact device; the electronic cigarette only needs to be close to the contact device; as the magnetic member on the contact device magnetically attracts the electronic cigarette, good contact between the electronic cigarette and the contact device is realized; meanwhile, as the operation of the rotatable connection is omitted, poor contact is avoided to occur due to poor rotation.

### CROSS-REFERENCE TO RELATED APPLICATION

This application claims the benefit of China Patent Application No. 201120561232.6, filed on Dec. 29, 2011 in the State Intellectual Property Office of the People's Republic of China, the disclosure of which is incorporated herein in its entirety by reference.

### BACKGROUND OF THE INVENTION

1. Field of the Invention

The present invention generally relates to the technical field of a charger used for an electronic cigarette, in particular to a contact type charging device used for the electronic cigarette.

2. Description of the Related Art

With the enhancement of people's health awareness, people have recognized more and more profoundly that smoking is harmful to health. Therefore, there are more and more smoking cessation auxiliary products presented in markets, wherein an electronic cigarette is the most common smoking cessation auxiliary product.

The electronic cigarette is also known as a virtual cigarette and an electronic atomizer. It has the appearance the same with that of the cigarette and the taste similar to that of the cigarette and is mainly used for smoking cessation and alternative cigarette. It is a non-burning cigarette-type alternative product. The electronic cigarette does not burn, does not contain tar and does not contain a variety of chemicals which are produced by the ordinary cigarette and cause respiratory and cardiovascular diseases; therefore, the carcinogens in the ordinary cigarette are eliminated, and there are not passive smoking toward others and environmental pollution.

The electronic cigarette requires to be charged after it has been used for a period time. An interface used in the charger of the electronic cigarette currently and commonly is generally a thread interface. The electronic cigarette is charged only after the electronic cigarette and the thread interface are in rotation butt joint. However, such charging method also does not have less drawbacks: firstly, being not convenient: When the electronic cigarette and the charger are in butt joint, the electronic cigarette needs to be rotated for several times; then the butt joint is realized, and the butt joint process is relatively cumbersome; secondly, having ineffective use: If the electronic cigarette is not rotated to be in place, good contact between the electronic cigarette and the thread interface cannot be formed, which causes poor contact and hence affects the normal charging of the electronic cigarette.

### SUMMARY OF THE INVENTION

According to one aspect of the invention, the invention provides a contact type charging device used for an electronic cigarette, comprising a bearing unit and a contact device located in the bearing unit. The contact device comprises an electronic sheet provided with a through hole at the center thereof and an electrode thimble, wherein the contact device further comprises a magnetic member. When the electronic cigarette is charged by such charging device and a battery part of the electronic cigarette is close to the contact device, as the positive and the negative electrodes of a battery of the electronic cigarette are usually made of stainless steel or other permeability magnetic materials, the magnetic member in the invention produces magnetic force to attract the battery part of the electronic cigarette; therefore, the battery part of the electronic cigarette is facilitated to be placed at the contact device accurately, and good contact therebetween is facilitated to be realized.

In some embodiments, the magnetic member is a ring-shaped permanent magnet of which the inner diameter is longer than the diameter of the electrode thimble, so that the electrode thimble is conveniently passed through the magnetic member while the magnetic member in the invention also adopts a ring-shaped electromagnet.

In some embodiments, the tip of the electrode thimble is upward. The bottom of the electrode thimble is provided with a jacking spring. Through the elastic force of the jacking spring, the good contact is produced between the electrode thimble and the battery of the electronic cigarette, thus guaranteeing use effectiveness better.

In some embodiments, the bearing unit is a base comprising an upper cover, a bottom cover and an opening cover. The surface of the upper cover is provided with a slope-shaped groove in which a plug hole is provided. The contact device is positioned in the plug hole.

In some embodiments, the opening cover covers the groove on the surface of the upper cover, and one side of the opening cover is connected with the bottom cover. The opening cover and the bottom cover are in hinge joint, and the two ends of the opening cover are respectively provided with a returning spring. When the opening cover and the upper cover are not used usually, they are closed therebetween, that is, the opening cover covers the groove on the surface of the upper cover, thus playing the role of preventing dust, preventing the dust and the debris from falling into a plug hole and then hindering good contact between the contact device and the electronic cigarette. A closing end between the opening cover and the upper cover is provided with an opening of which the size is the same with that of a thumb, thus facilitating the user to directly open the cover and then implement charging operation. After the electronic cigarette is charged completely and moved out, due to action of the spring force of a returning spring at two ends of the opening cover, the opening cover is automatically returned and covers on the groove on the surface of the upper cover again.

In some embodiments, the bottom cover is a concave-shaped structure and provided with a counter weight block, a PCBA circuit board, a light guiding board and a light blocking board in sequence. The counter weight block may be made of materials with relatively big density, such as tin, copper and so on. Through the counter weight block provided on the bottom cover, the stability of the invention may be enhanced, so that the electronic cigarette is not easily dumped when it is charged.

In some embodiment, the bottom of the bottom cover is provided with a non-slip foot pad; therefore, when the electronic cigarette is placed on a desk, it slides on the smooth desk.

In some embodiments, the bearing unit is a charging connector provided with a column-shaped cavity into which the electronic cigarette is to be inserted. the contact device is located at the bottom of the column-shaped cavity. If the electronic cigarette to be charged is inserted into the column-shaped cavity of the charging connector, it is attracted by the magnetic member of the contact device, thus facilitating the electronic cigarette and the contact device to be closely contacted.

The electronic cigarette has the advantages that: As the magnetic member is provided on the contact device, the charging device is used more conveniently; rotation connection needs not to be provided between the electronic cigarette and the contact device, and the electronic cigarette only needs to be close to the contact device. Through the magnetic force produced by the magnetic member on the contact device and attracting the electronic cigarette, good contact between the electronic cigarette and the contact device is realized. Meanwhile, as the operation of the rotation connection is omitted, poor contact, due to rotation being not in place, is avoided.

### BRIEF DESCRIPTION OF THE DRAWINGS

FIG. 1 is a sectional view of the use state of a contact type charging device used for an electronic cigarette according to Example 1 of the invention.

FIG. 2 is an exploded view of the use state of a contact type charging device used for an electronic cigarette according to Example 1 of the invention.

FIG. 3 is an exploded view according to Example 2 of the invention.

FIG. 4 is an exploded view according to Example 3 of the invention.

### DETAILED DESCRIPTION OF THE PREFERRED EMBODIMENTS

The technical contents and characteristics of the present invention will be apparent with the detailed description of a preferred embodiment accompanied with related drawings as follows. For simplicity, the same numerals are used for the same respective elements in the description of the following preferred embodiments and the illustration of the drawings. The invention is further described in details with the combination with drawings and embodiments in the following:

### Example 1

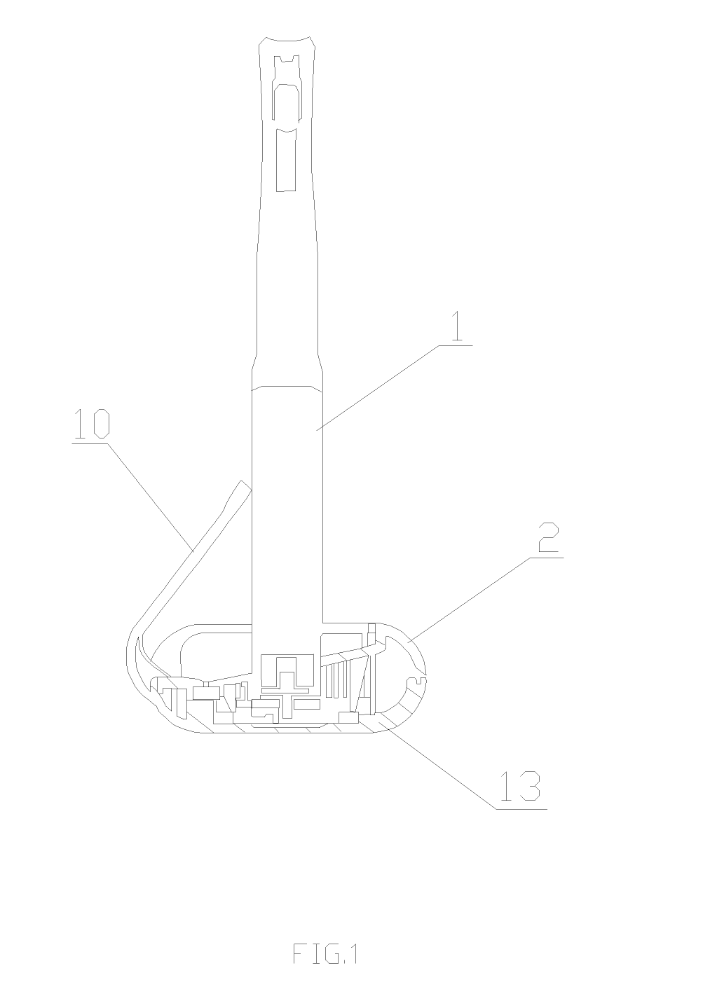

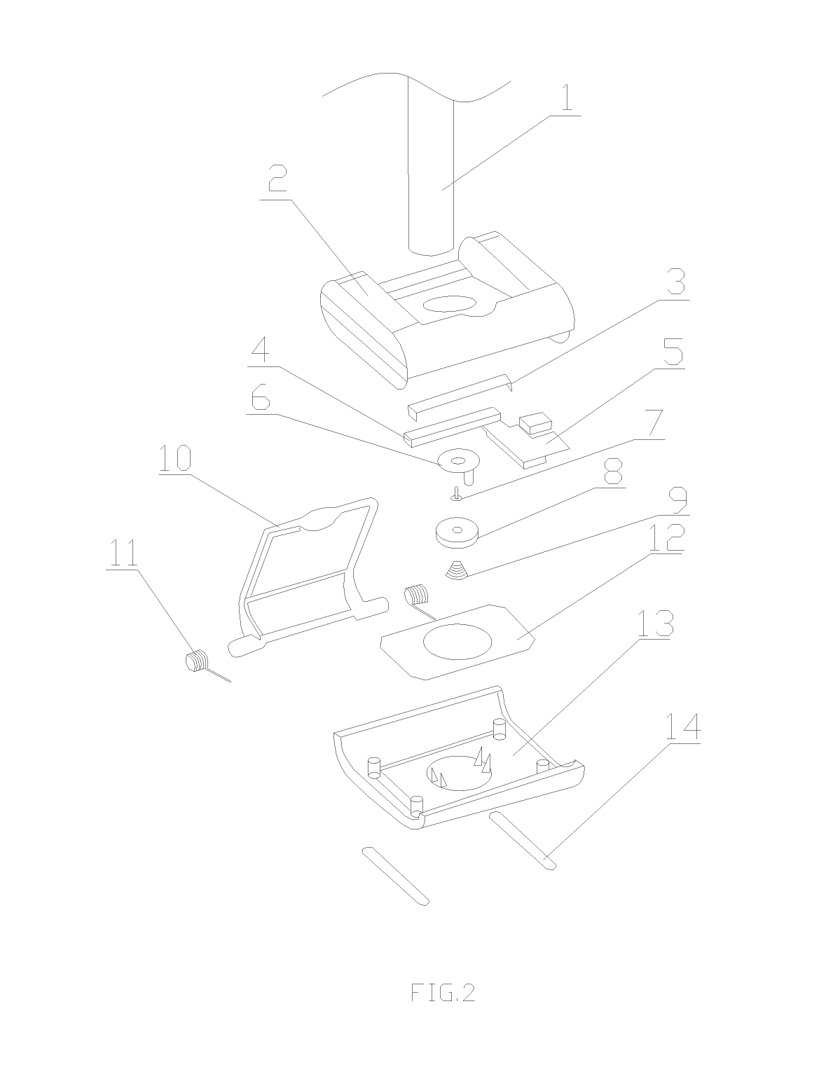

As shown in FIGS. 1 and 2, a contact type charging device used for an electronic cigarette comprises a base and a contact device located on the base.

The base comprises three parts consisting of an upper cover 2, a bottom cover 13 and an opening cover, wherein the surface of the upper cover is provided with a slope-shaped groove in which a plug hole is provided, and the contact device is rightly located in the plug hole. When the electronic cigarette needs to be charged, the electronic cigarette 1 is inserted in the plug hole. The opening cover 10 covers the groove on the surface of the upper cover 2. One side of the opening cover 10 is connected with the bottom cover 13. Hinge connection is provided between the opening cover 10 and the bottom cover 13. Two ends of the opening cover 10 are respectively provided with a returning spring 11. When the electronic cigarette is not used, the opening cover 10 on the base is closed, thus playing a role of dust prevention. When charging operation needs to be implemented, the opening cover 10 is opened and hence exposes the plug hole provided on the upper cover 2 below the opening cover 10. The electronic cigarette is inserted in the plug hole and then may be charged. When the electronic cigarette is completely charged and moved out, due to the action of a returning spring 11 at two ends of the opening cover 10, the opening cover 10 is automatically returned and closed. The bottom cover 13 is an integral concave-shaped structure and provided with a counter weight block 12, a PCBA circuit board 5, a light guiding board 4 and a light blocking board 3 in sequence. The counter weight block 12 may guarantee the center of weight balance of the whole charging device and thus maintains stability. The PCBA circuit board 5 is one control circuit board controlling the whole charging process. It adopts the prior art, for example, the PCBA circuit board in ZD-9585 mode produced by Shenzhen Zhidian Technology Co, Ltd. The charging device is also provided with an indicating lamp. The light blocking board 3 may facilitate the light of the indicating lamp to be emitted from a specific part. The light guiding board 4 may facilitate light to be guided out of the specific place. The bottom of the bottom cover 13 is provided with a non-slip pad 14, thus preventing the whole device from being slid and maintaining stability.

The contact device comprises an electrode sheet 6 provided at the center thereof, an electrode thimble 7 and a magnetic member 8. The magnet member 8 in the invention adopts a ring-shaped permanent magnet of which the inner diameter is longer than the diameter of the electrode thimble 7, thus conveniently facilitating the electrode thimble 7 to be passed through the ring-shaped permanent magnet located below the electrode sheet 6. The tip of the electrode thimble 7 is upward and the bottom end of the electrode thimble is provided with a jacking spring 9. With the spring force of the jacking spring, the electrode thimble 7 has upward force. When the electronic cigarette is charged and when it is close to the contact device, due to the magnetic property of the magnetic member 8, the electronic cigarette is attracted to be on the contact device, thus completing butt joint automatically. The electrode sheet 6 and the electrode thimble 7 are respectively connected with the positive and the negative electrodes of the electronic cigarette. Due to the attraction of the magnetic member, the electrode cigarette has one downward force. Due to the elastic force of the jacking spring 9, the electrode thimble 7 has one upward force, thus guaranteeing the good contact between the electrode cigarette and the contact device.

### Example 2

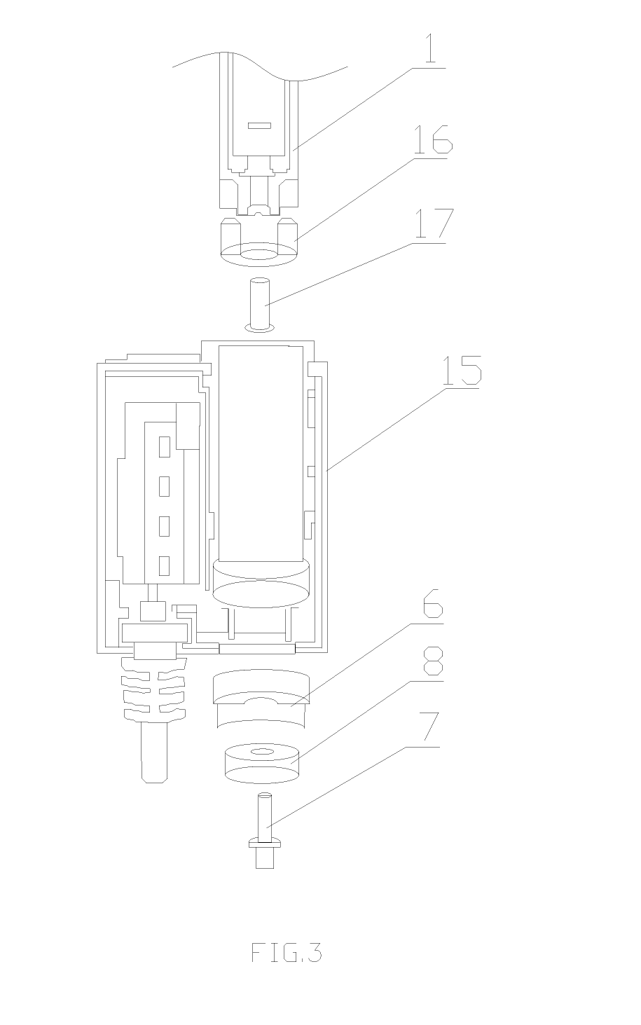

As showed in FIG. 3, a contact type charging device used for an electronic cigarette comprises a charging connector 15 and a contact device, wherein the charging connector is provided with one column-shaped cavity into which the electronic cigarette is inserted, and the contact device is located at the bottom of the column-shaped cavity and comprises an electrode sheet 6 provided with a through hole at the center thereof, an electrode thimble 7 and a magnetic member 8. The magnetic member 8 in the invention adopts a ring-shaped permanent magnet of which the inner diameter is longer than the diameter of the electrode thimble 7, thus facilitating the electrode thimble 7 to be passed through the ring-shaped permanent magnet located below the electrode sheet 6. The tip of the electrode thimble 7 is upward. The bottom of a battery of the electronic cigarette is provided with a positive iron ring 16 and a negative electrical column 17. When the battery part of the electronic cigarette to be charged is inserted into the column-shaped cavity of the charging connector, as the attracting force toward the positive electrode iron ring is produced by the magnet part 8 in the contact device, the whole electronic cigarette is attracted firmly. The electrode sheet 6 may be closely contact with the positive iron ring 16, and the electrode thimble 7 may be closely contact with the negative electrode electrical column 17, thus eliminating the rotation troublesome needed when a common battery device is charged, and further avoiding poor contact when the rotation is not in place.

### The Example 3

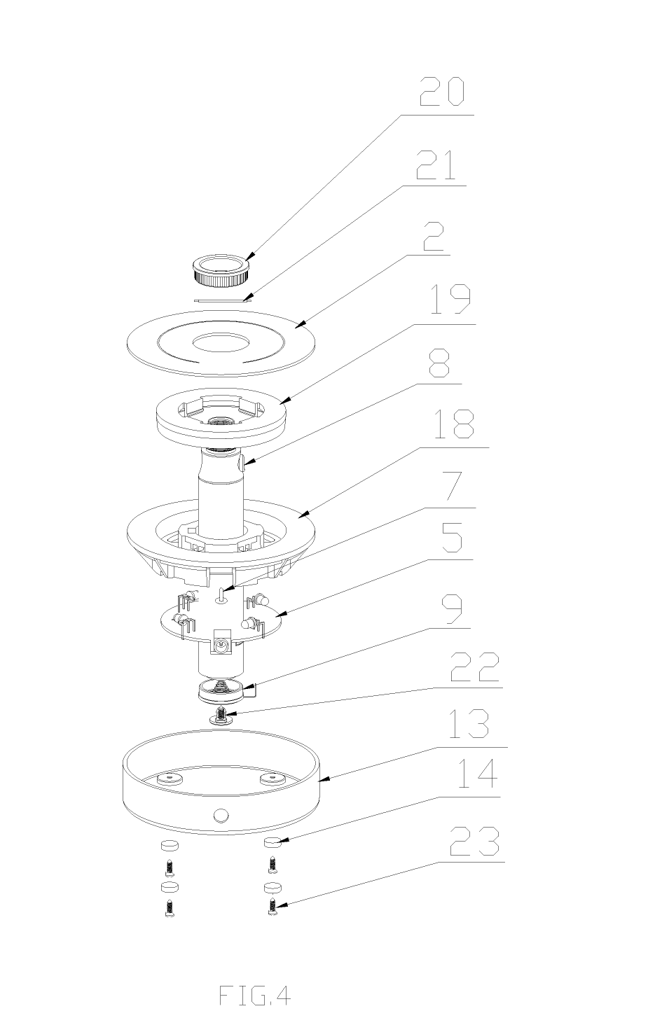

As shown in FIG. 4, a contact type charging device used for an electronic cigarette comprises a base and a contact device located on the base.

The base comprises an upper cover 2, a bottom cover 13 and a copper scope ring 20, wherein the surface of the upper cover is provided with a ring-shaped groove in which one plug hole is provided. The copper scope ring 20 is provided on the plug hole. The contact device is rightly positioned in the plug hole. When the electronic cigarette needs to be charged, the electronic cigarette is inserted in the plug hole. If the electronic cigarette is inserted in the plug hole, it then may be charged. The bottom cover 13 is a disk-shaped structure. The structure, which is on the bottom, is provided with a PCBA circuit board 5, a PCB frame 18 and a light guiding ring 19 in sequence. The PCBA circuit board 5 is one control circuit board controlling the whole charging process. It adopts the prior art, for example, the PCBA circuit board in ZD-9585 mode produced by Shenzhen Zhidian Technology Co, Ltd. The charging device is also provided with an indicating lamp. The light blocking ring 19 may facilitate the light of indicating lamp to be emitted out of a specific part. The light guiding ring 19 may facilitate light to be guided out of the specific place. The bottom of the bottom cover 13 is provided with a non-slip pad 14 fixed at the bottom of a bottom disk 13 with a bolt 23, thus preventing the whole device from sliding, and maintaining stability.

The contact device comprises an electronic wire 21, an electrode thimble 7 and a magnetic member 8. In the Example, the magnetic member 8 adopts a ring-shaped permanent magnet located above the electrode thimble 7. The tip of the electrode thimble 7 is upward. The bottom end of the electrode thimble is provided with a jacking spring 9. The jacking spring 9 is fixed at the bottom of the PCBA circuit board 5 through a self-tapping screw 22. Through the elastic force of the jacking spring 9, the electrode thimble 7 has an upward force. When the electronic cigarette is charged and when the electronic cigarette is close to the contact device, due to the magnetic property of the magnetic member 8, the electronic cigarette is attracted to be on the contact device and the butt joint is automatically completed. An electronic wire 21 and the electrode thimble 7 are respectively connected with the positive and the negative electrodes of the electronic cigarette. Due to the attraction of the magnetic member 8, the electronic cigarette has one downward force. Due to the elastic force of the jacking spring 9, the electrode thimble 7 has an upward force, thus guaranteeing good contact between the electronic cigarette and the contact device.

What is claimed is:

1. A contact type charging device used for an electronic cigarette, comprising:
a bearing unit and a contact device located in the bearing unit, the contact device comprising an electronic sheet provided with a through hole at the center thereof and an electrode thimble, wherein the contact device further comprising a magnetic member.

2. The contact type charging device used for the electronic cigarette according to claim 1, wherein the magnetic member is a ring-shaped permanent magnet of which the inner diameter is longer than the diameter of the electrode thimble.

3. The contact type charging device used for the electronic cigarette according to claim 2, wherein the tip of the electrode thimble is upward, and the bottom end of the electrode thimble is provided with a jacking spring.

4. The contact type charging device used for the electronic cigarette according to claim 1, wherein the bearing unit is a base comprising an upper cover, a bottom cover and an opening cover; the surface of the upper cover is provided with a slope-shaped groove in which a plug hole is provided, and the contact device is positioned in the plug hole.

5. The contact type charging device used for the electronic cigarette according to claim 4, wherein the opening cover covers the groove on the surface of the upper cover, and one side of the opening cover is connected with the bottom cover.

6. The contact type charging device used for the electronic cigarette according to claim 5, wherein the opening cover and the bottom cover are in hinge joint, and the two ends of the opening cover are respectively provided with a returning spring.

7. The contact type charging device used for the electronic cigarette according to claim 6, wherein the bottom cover is a concave-shaped structure and provide with a counter weight block, a PCBA circuit board, a light guiding board and a light blocking board in sequence.

8. The contact type charging device used for the electronic cigarette according to claim 7, wherein the bottom of the bottom cover is provided with a non-slip pad.

9. The contact type charging device used for the electronic cigarette according to claim 2, wherein the bearing unit is a base comprising an upper cover, a bottom cover and an opening cover; the surface of the upper cover is provided with a slope-shaped groove in which a plug hole is provided, and the contact device is positioned in the plug hole.

10. The contact type charging device used for the electronic cigarette according to claim 9, wherein the opening cover covers the groove on the surface of the upper cover, and one side of the opening cover is connected with the bottom cover.

11. The contact type charging device used for the electronic cigarette according to claim 10, wherein the opening cover and the bottom cover are in hinge joint, and the two ends of the opening cover are respectively provided with a returning spring.

12. The contact type charging device used for the electronic cigarette according to claim 11, wherein the bottom cover is a concave-shaped structure and provide with a counter weight block, a PCBA circuit board, a light guiding board and a light blocking board in sequence.

13. The contact type charging device used for the electronic cigarette according to claim 12, wherein the bottom of the bottom cover is provided with a non-slip pad.

14. The contact type charging device used for the electronic cigarette according to claim 3, wherein the bearing unit is a base comprising an upper cover, a bottom cover and an opening cover; the surface of the upper cover is provided with a slope-shaped groove in which a plug hole is provided, and the contact device is positioned in the plug hole.

15. The contact type charging device used for the electronic cigarette according to claim 14, wherein the opening cover covers the groove on the surface of the upper cover, and one side of the opening cover is connected with the bottom cover.

16. The contact type charging device used for the electronic cigarette according to claim 15, wherein the opening cover and the bottom cover are in hinge joint, and the two ends of the opening cover are respectively provided with a returning spring.

17. The contact type charging device used for the electronic cigarette according to claim 16, wherein the bottom cover is a concave-shaped structure and provide with a counter weight block, a PCBA circuit board, a light guiding board and a light blocking board in sequence.

18. The contact type charging device used for the electronic cigarette according to claim 17, wherein the bottom of the bottom cover is provided with a non-slip pad.

19. The contact type charging device used for the electronic cigarette according to claim 1, wherein the bearing unit is a charging connector provided with a column-shaped cavity into which the electronic cigarette is to be inserted. The contact device is located at the bottom of the column-shaped cavity.

20. The contact type charging device used for the electronic cigarette according to claim 2, wherein the bearing unit is a charging connector provided with a column-shaped cavity into which the electronic cigarette is to be inserted. The contact device is located at the bottom of the column-shaped cavity.
